(19) United States
(12) Patent Application Publication
(10) Pub. No.: US 2008/0270195 A1
(43) Pub. Date: Oct. 30, 2008

(54) SYSTEM AND METHOD FOR FINANCING WELFARE BENEFITS TRUST

(76) Inventor: Joshua L. GOTTLIEB, Chagrin Falls, OH (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/109,949

(22) Filed: Apr. 25, 2008

Related U.S. Application Data
(60) Provisional application No. 60/913,933, filed on Apr. 25, 2007.

(51) Int. Cl. G06Q 40/00

(52) U.S. Cl. 705/4

(57) ABSTRACT

A sophisticated benefits financing and life insurance strategy that provides life insurance benefits for members with no cost to members, provides for funding of the strategy, and potentially building excess funds after payment of benefits and repayment of debt for the benefit of current and future members. A welfare benefits trust is first established by a respective legal entity. A funding amount is then received, the amount of which is calculated based on stochastic actuarial models and modern financial theory to provide purchasing of life insurance and/or other benefits for respective members of the welfare benefits plan, of extension risk coverage, and the development of cash value attributable to each of the plan members as is actuarially determined to be appropriate. Upon the death of a plan member, the welfare benefits trust arranges for payment of the member benefit and repays the funding amount attributable to the deceased member, together with accrued interest. The welfare benefits trust retains the excess proceeds.

### CROSS-REFERENCE TO RELATED APPLICATIONS

The subject application claims priority to U.S. Provisional Patent Application No. 60/913,933, filed Apr. 25, 2007, the entirety of which is incorporated herein by reference.

### BACKGROUND OF THE INVENTION

The subject application relates generally to a benefits financing strategy and, more specifically, to a system and method for financing the cost for a welfare benefits trust that provides customized solutions for members' life insurance, other welfare benefits, and financing of benefits. In particular, the subject application is directed to a system and method that allow members' beneficiaries to receive life insurance and other welfare benefits without any out-of-pocket costs to the members or the sponsoring organization.

Life insurance is a contract between the policy owner and the insurer, according to which the policy owner agrees to pay single or periodic payments, or “premiums,” to insure a life or lives and, in turn, the insurer agrees to pay a sum of money upon the occurrence of the insured's death. In return, the policy payer (who may be the owner, the insured, or some other person or entity) agrees to pay premiums to the insurer. The insured person and the policy owner may or may not be the same party. As with most insurance polices, life insurance is a contract between the insurer and the policy owner whereby a benefit is paid to the beneficiary or beneficiaries (as designated, from time to time, by the policy owner) upon the occurrence of an event that is covered by the policy. Insured events that may be covered typically include death. The policy owner may be entitled to other benefits during the life of the insured, such as policy loans, withdrawals, and/or partial surrenders in the case of a policy that develops cash value (the cash fund within the policy). Some companies (a governmental entity, a private company, a publicly traded company, a corporation, an association, a union, including multiple entities or organizations, and the like) grant welfare benefits such as health care, disability, and life insurance; educational cost reimbursement programs; and reduced travel costs to their employees/members. However, welfare benefits may become a big financial burden to the companies, as the number of members and the cost of funding these benefits increase. In some cases, the benefits are provided from a trust that is subject to the “Employee Retirement Income Security Act of 1974,” which is a U.S. federal law that regulates most private sector employee benefit plans (“ERISA”).

A financed welfare benefits trust is a trust that obtains funds from a third party to fund a portion or all of the benefits provided by the welfare benefits trust, rather than exclusively utilizing the funds of the welfare benefits trust and/or the company that established the welfare benefits trust to provide such benefits.

A special purpose captive insurance company is a limited purpose insurance company established with the specific objective of insuring against specifically-defined risks emanating from a designated legal entity or group of legal entities. The special purpose captive insurance company may insure against such risks itself, or it may purchase other insurance, or “re-insurance,” to insure against a portion or all of such risks.

### SUMMARY OF INVENTION

In accordance with the subject application, there is provided a system and method for a financed welfare benefits trust that provides customized solutions for life insurance and other welfare benefits for employees, association, and union members and for financing such benefits.

Further in accordance with the subject application, there is provided a system and method for a financed welfare benefits trust that build long term assets within the trust for the benefit of members of an entity, which entity is capable of being an employer, a union, or other association.

Still further in accordance with the subject application, there is provided a system for a financed welfare benefits trust, the system including a legal entity, such as a governmental entity, a private company, a publicly traded company, a corporation, an association, a union, including multiple entities or organizations, and the like. The system further includes a welfare benefits trust, one or more lenders to the welfare benefits trust, and at least one special purpose captive insurance company. Also included in the system may be at least one life insurance carrier, at least one life re-insurance carrier, at least one extension risk carrier, and one or more asset management institutions. According to one embodiment, the roles of the at least one life insurance carrier, the at least one life re-insurance carrier, the at least one extension risk carrier and/or the one or more asset management institutions are capable of being undertaken by the special purpose captive insurance company. In accordance with another embodiment of the subject application, the roles of the lenders are capable of being performed by purchasers of bonds or other debt instruments issued by the welfare benefits trust, the at least one special purpose captive insurance company, and/or other legal entity.

According to one embodiment of the subject application, a welfare benefits trust is first established by a respective legal entity, which legal entity is capable of being a governmental entity, a private company, a publicly traded company, a corporation, an association, a union, including multiple entities or organizations, and the like. The welfare benefits trust then establishes a benefits program for its associated members that is capable of being a life insurance benefit program. In the event that the welfare benefits trust establishes a life insurance benefit program, the welfare benefits trust is further capable of establishing a group life insurance plan with at least one additional insurance carrier. Next, one or more loans are received by the welfare benefits trust from a lender and/or, in the event that bonds are issued by the welfare benefits trust, bonds are sold and the welfare benefits trust receives the net proceeds from such bond sales. The total amount of the loan proceeds and the bond sale proceeds is calculated based on stochastic actuarial models and modern financial theory to provide purchasing of life insurance coverage for respective members of the welfare benefits plan and of extension risk coverage, to develop a policy cash value fund, and to meet the expenses of the at least one special purpose captive insurance company. According to one embodiment of the subject application, the legal entity or another entity is capable of funding a portion of the amounts required by the welfare benefits trust to provide purchasing of life insurance coverage for respective members of the welfare benefits plan and of extension risk coverage, to develop a policy cash value fund, and to meet the expenses of a special purpose captive insurance company. The members of the welfare benefits plan are capable of being employees, union members, association members, and the like. The loan proceeds and/or the bond sale proceeds received by the welfare benefits trust are then transferred to the at least one special purpose captive insurance company that provides the life insurance coverage and the extension risk coverage through a policy of life insurance issued by the special purpose captive insurance company to the welfare benefits trust. The at least one special purpose captive insurance company is capable of self-insuring the life insurance coverage and/or the extension risk coverage or re-insuring a portion or all of such coverage from a life re-insurance carrier and a extension risk carrier, which role is capable of being undertaken by at least one additional special purpose captive insurance company. The at least one special purpose captive insurance company also provides for asset management of the cash value fund and other assets by a respective asset management institution, such as world class fixed income managers, in accordance with pre-established investment policy statements and applicable state and federal requirements.

The extension risk coverage provides a financial guarantee from a third-party financial institution, or from the at least one special purpose captive insurance company, and is capable of including specific provisions with respect to payment of proceeds from the policy at a future date certain. For example, the extension risk policy is capable of determining that the proceeds of the policy will be paid when the insured person attains a certain age, such as age 75, or has accrued a certain time, 20 years for example, of participation in the plan or any combination thereof.

According to another embodiment of the subject application, the welfare benefits trust is capable of being obligated to pay a portion or all of the accrued interest to one or more lenders or bond holders periodically during the term of the loans or until maturity of the bonds. The life insurance policy issued by the special purpose captive insurance company to the welfare benefits trust suitably provides the ability of the trust to borrow or withdraw against a cash value associated with the life insurance policy from time to time for the purpose of making such periodic interest payments, upon a determination that the assets of the welfare benefits trust are inadequate to make such periodic payments.

When a death event occurs for a plan member, the life insurance proceeds on the life of the deceased plan member are paid from the life re-insurance carrier to the at least one special purpose captive insurance company in accordance with the previously purchased re-insurance policy, if any. The value of the policy cash value fund that is attributable to the deceased plan member is further paid to the special purpose captive insurance company by an asset management institution. The extension risk coverage for this plan member lapses at this point. The at least one special purpose captive insurance company then pays to the welfare benefits trust the life insurance benefit, which consists of the collected re-insurance proceeds or the proceeds of the coverage self-insured by the special purpose captive insurance company, and the proceeds from the policy cash value fund in accordance with the provisions of the life insurance policy issued by the special purpose captive insurance company to the welfare benefits trust at the outset. The welfare benefits trust then pays the lender loan balance attributable to the deceased plan member, together with accrued interest, and funds the group life insurance plan with the life insurance carrier for that deceased member. The life insurance carrier pays the member benefit to the deceased member's beneficiaries. The welfare benefits trust is capable of using the excess proceeds for additional member benefits or to reduce further the amount of its outstanding loans, if required by the lender. In the event that the welfare benefits trust has issued bonds to fund all or a portion of the premium it has paid to the special purpose captive insurance company, the welfare benefits trust is capable of retiring some of those bonds. In either event, the welfare benefits trust is capable of retaining the excess proceeds to meet future loan or bond payment obligations. In one embodiment, the welfare benefits trust further invests the excess proceeds pursuant to the welfare benefits trust's investment policy statement, the requirements of the lenders and/or the bonds issued by the welfare benefits trust, and applicable state and federal requirements.

In another embodiment, when a member has met the requirements of the extension risk coverage, e.g. age 75 and 20 years participation in the plan, the welfare benefits trust is capable of electing to collect the proceeds of the extension risk coverage. In such an event, the extension risk carrier purchases from the at least one special purpose captive insurance company the life insurance coverage, which consists of the re-insurance coverage or the amount of the coverage self-insured by the special purpose captive insurance company, and cash value attributable to such qualifying member, in exchange for the proceeds of the extension risk coverage attributable to such member. The at least one special purpose captive insurance company then pays the proceeds of the extension risk coverage attributable to such member to the welfare benefits trust, whereupon the procedure of paying back the lender and/or bond holder is analogous to that described above. The amount of the extension risk coverage is actuarially determined to provide the welfare benefits trust with sufficient proceeds to retire the outstanding principal and accrued interest on the loans and/or the bonds and/or other debt instruments attributable to such qualifying member and to retain the present value of its future benefit obligations to such qualifying member. The extension risk carrier retains the life re-insurance proceeds or the proceeds of the coverage self-insured by the special purpose captive insurance company that are payable upon the death of the member.

Still other objects, advantages, and aspects of the present invention will become s readily apparent to those skilled in the art from the following description, wherein there is shown and described a preferred embodiment of this invention, simply by way of illustration of one of the best modes suited to carry out the invention. As it will be realized by those skilled in the art, the invention is capable of other different embodiments, and its several details are capable of modifications in various obvious aspects, all without departing from the invention. Accordingly, the drawings and description will be regarded as illustrative in nature and not as restrictive.

### BRIEF DESCRIPTION OF THE DRAWINGS

The accompanying drawings illustrate several aspects of the subject application and, together with the description, serve to explain the principles of the subject application, including:

FIG. 1 is a schematic diagram illustrating the method for a financed welfare benefits trust in accordance with one embodiment of the subject application; and

FIG. 2 is a flowchart illustrating the method for a financed welfare benefits trust in accordance with one embodiment of the subject application.

### DETAILED DESCRIPTION OF THE PREFERRED EMBODIMENT

The subject application is directed to a system and method for a financed welfare benefits trust that provides customized solutions for member life insurance, other welfare benefits, and financing of benefits. In one particular embodiment, the subject application is directed to a system and method for a financed welfare benefits trust that build long term assets in the trust for the benefit of members of an entity, which entity is capable of being an employer or union. More particularly, one embodiment of the subject application is directed to a system and method for a financed welfare benefits trust, the system including a legal entity such as a governmental entity, a corporation, a publicly traded company, a private company, an association, a union, including multiple entities or organizations, and the like. The system offers life insurance coverage to all active members and provides a predefined amount of life insurance such as, for example, $50,000 for participating members' beneficiaries.

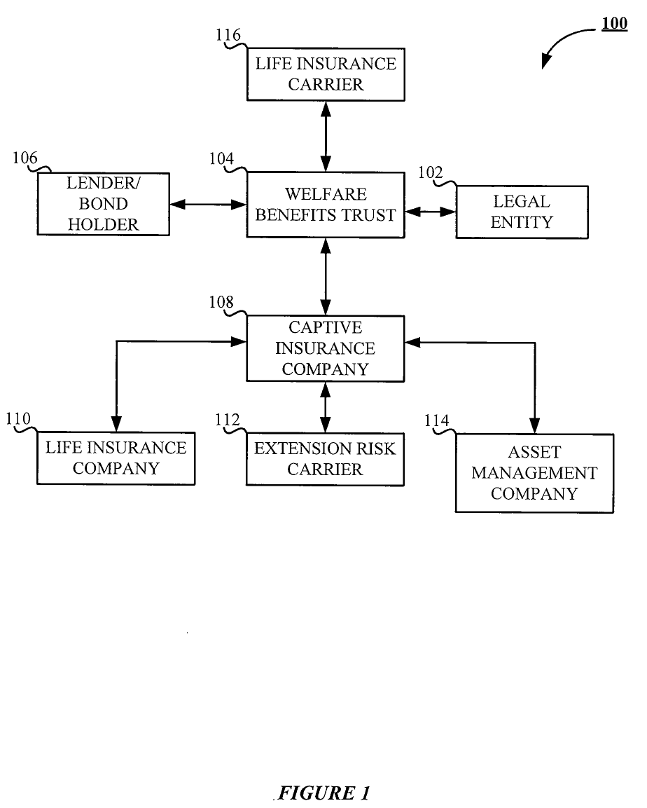

Turning now to FIG. 1, there is shown a system 100 for a financed welfare benefits trust. The system 100 includes a legal entity 102 such as a governmental entity, a corporation, a publicly traded company, a private company, an association, a union, including multiple entities or organizations, and the like. The system 100 further includes a welfare benefits trust 104, a lender 106, and at least one special purpose captive insurance company 108. It will be appreciated by those skilled in the art that the lender 106 is capable of including one or more holders of debt instruments issued by the welfare benefits trust 104, e.g. bond holders. Thus, the skilled artisan will appreciate that reference is made hereinafter to the lender/holder 106 for example purposes only. Those skilled in the art will appreciate that the welfare benefits trust 104 is established by the legal entity 102 for managing welfare benefits. As will be further recognized by those skilled in the art, captive insurance companies 108 are known to be limited purpose insurance companies established with the specific objective of insuring against specifically-defined risks emanating from a designated legal entity or a group of legal entities. Thus, the at least one special purpose captive insurance company 108 is capable of being a cell of an existing captive insurance company, with the welfare benefits trust 104 being its sole client. It will be appreciated by those skilled in the art that, while reference is made herein to a single special purpose captive insurance company 108 in FIG. 1, any number of suitable such special purpose companies are capable of being used in the implementation of the subject application. In addition, the skilled artisan will appreciate that the domicile of such a special purpose captive insurance company 108 is capable of being domestic, international, or the like, so as to take advantage of the relevant laws and regulations relating thereto.

As will be further appreciated by those skilled in the art, the special purpose captive insurance company 108 is advantageously capable of being guided by insurance regulations, by the welfare benefits trust 104, by requirements of the lender/holder 106 and covenants, and by the “Employee Retirement Income Security Act of 1974,” which is a U.S. federal law that regulates most private sector employee benefit plans (“ERISA”). Also included in the system are a life insurance institution 110, an extension risk carrier 112, and an asset management institution 114. In accordance with one embodiment of the subject application, the life insurance institution 110 includes, for example and without limitation, a life re-insurance carrier or the like. A skilled artisan will further appreciate that the life insurance institution 110, although indicated in FIG. 1 as life insurance company 110, is capable of including, when appropriate, multiple life insurance companies. The lender/holder 106, extension risk carrier 112, and the asset management institution 114 are also capable of including multiple respective companies.

It will be appreciated by those skilled in the art that, while reference is made in the example embodiment to the life insurance provided by the welfare benefits trust 104 to members comprising a group life benefit, other life insurance benefits are equally capable of being provided in accordance with the subject application. For example, the benefits are capable of being issued as individual life insurance policies, whether directly and solely by the at least one special purpose captive insurance company 108 or through the captive company 108, and fully reinsured to and through other insurance companies, i.e. the life insurance carrier 110, the additional life insurance carrier 116, or the like. The skilled artisan will therefore appreciate that the life insurance benefit is engineered so as to have no living cost to the members.

According to one example embodiment of the subject application, a benefit is provided to the trust 104 that is essentially a “put” or an option by the welfare benefits trust 104 (the policy holder) to exchange its rights to the life insurance benefit (including all cash value and any other policy rights) with the special purpose captive insurance company 108 issuing the coverage for an actuarially-projected amount that will provide ample funds to the welfare benefits trust 104 to pay off all debt associated with each eligible life, plus a projected cost of capital on such loans and/or debt obligations plus the present value of the death benefit expected to be paid to the member's beneficiaries upon his/her life expectancy. Preferably, the welfare benefits trust 104 is able to relieve any obligations to non-members and become responsible for having ample cash in the trust to self-insure the costs of the benefits for each member associated with this “put” option that the welfare benefit trust 104 has elected to exercise. The “put” obligation (benefit) referenced above with respect to benefits associated with the welfare benefits trust 104 is preferably reinsured with an affiliated special purpose captive insurance company. The premium associated with such a “put” option benefit is part of a premium payment paid to the special purpose captive insurance company 108 at the outset in accordance with the provisions of the life insurance policy issued by the special purpose captive insurance company to the welfare benefits trust. The remaining cash from the premiums is suitably capable of being used by the special purpose captive insurance company to pay fees to providers of services and to be the cash value of the policies. In operation, the welfare benefits trust 104 is first established by the legal entity 102. As will be recognized by those skilled in the art, the legal entity 102 is capable of being a governmental entity, a private company, a publicly traded company, a corporation, an association, a union, including multiple entities or organizations, and the like. The welfare benefits trust 104 then establishes a life insurance benefit program for its associated members and a group life insurance plan with a life insurance company 116. Next, a loan, i.e. a funding amount, is received by the welfare benefits trust 104 from the lender/holder 106. According to another embodiment of the subject application, the welfare benefits trust 104 issues a plurality of debt instruments, e.g. bonds, which are purchased to fund the welfare benefits trust 104. In accordance with one example embodiment of the subject application, the special purpose captive insurance company 108 is also capable of functioning as a funding source, so as to realize a greater return. The funding amount is calculated based on stochastic actuarial models and modern financial theory to provide purchasing of life insurance coverage and other actuarially-determined benefit costs for respective members of the welfare benefits plan and of extension risk coverage and for developing a policy cash value fund. As is known in the art, actuarial science is a branch of knowledge dealing with the mathematics of insurance, including probabilities. It is used in ensuring that risks are carefully evaluated, that adequate premiums are charged for risks underwritten, and that adequate provision is made for future payments of benefits. Actuarial assumptions and methods are more likely to be accurate when used for large groups of lives.

The members of the welfare benefits plan are capable of being employees, union members, and the like. As will be recognized by those skilled in the art, the loan is non-recourse to legal entity 102. The loan is specially designed to limit recourse of the lender 106 to the assets of the welfare benefits trust 104 of the captive insurance company 108, including the captive insurance company's 108 invested assets that are managed by the asset management institution 114 and the claims against the life insurance companies 110, and of the extension risk carriers 112. In addition, the loan is tracked by the lender for each plan member, and the portion of the loan that is attributable to each plan member may be repaid as described herein. Similarly, when debt instruments have been issued by the welfare benefits trust 104, the portion of such debt attributable to each plan member may be repaid as described herein. The welfare benefits trust 104 then transfers the received funds to the special purpose captive insurance company 108, which issues a life insurance policy to the welfare benefits trust 104. The captive insurance company 108 purchases life insurance for associated plan members from respective life insurance companies 110. The skilled artisan will appreciate that the special purpose captive insurance company 108 is capable of self-insuring, re-insuring via another company, or otherwise procuring the life insurance set forth in the subject application. The special purpose captive insurance company 108 also negotiates extension risk coverage for each pool of lives from respective extension risk carriers 112. The captive insurance company 108 further provides for asset management by a respective asset management institution 114, such as world class fixed income managers, in accordance with pre-established investment guidelines and applicable state and federal requirements.

The extension risk coverage provides a financial guarantee from a third-party financial institution, such as the extension risk carrier 112, and is capable of including specific provisions with respect to payment of proceeds from the policy at a future date certain. For example, the extension risk policy is capable of determining that the proceeds of the policy will be paid when the insured person attains a certain age, such as age 75, and has accrued a certain time, 20 years for example, of participation in the plan or any combination thereof.

When a death event occurs for a plan member, the life insurance proceeds on the life of the deceased plan member are paid from the life re-insurance carrier 110 to the special purpose captive insurance company 108 in accordance with the previously purchased re-insurance policy, if any. The value of the policy cash value fund that is attributable to the deceased plan member is further paid to the special purpose captive insurance company 108 by the asset management company 114. Preferably, the captive insurance company 108 establishes and maintains individual premium and cash value fund values for each respective plan member. The extension risk coverage for this plan member suitably lapses at this point. The special purpose captive insurance company 108 then pays the life insurance benefits, which consist of the re-insurance proceeds or the proceeds of the coverage self-insured by the special purpose captive insurance company, and the proceeds from the policy cash value fund to the welfare benefits trust 104, in accordance with the provisions of the life insurance policy issued by the special purpose captive insurance company 108 to the welfare benefits trust 104. The welfare benefits trust 104 then pays the lender/holder 106 the loan/debt balance attributable to the deceased plan member, together with accrued interest, and funds the group life insurance plan with the at least one additional life insurance carrier 116 for that deceased member. The life insurance carrier 116 then pays the member benefit to the deceased member's beneficiaries. In the preferred embodiment, the role of the life insurance carrier 116 is undertaken by the special purpose captive insurance company 108; in which event, the special purpose captive insurance company 108 is capable of retaining the amount of the member benefit from the life insurance benefits otherwise payable to the welfare benefits trust 104 and of paying the member benefit to the deceased member's beneficiaries. The welfare benefits trust 104 is then capable of using the excess proceeds to reduce further the amount of outstanding loans and/or debt obligations. In the event that the welfare benefits trust 104 has issued bonds to fund all or a portion of the premium it has paid to the special purpose captive insurance company 108, the welfare benefits trust 104 is capable of retiring a corresponding portion of those bonds. In either event, the welfare benefits trust 104 is capable of retaining the excess proceeds for additional member benefits or to meet future loan or bond payment obligations, if required by the lender/holder. The welfare benefits trust further invests the excess proceeds pursuant to an investment policy statement associated with the welfare benefits trust 104, the requirements of the lenders 106 and/or the bonds issued by the welfare benefits trust 104, and any applicable state and/or federal requirements.

In accordance with another embodiment of the subject application, when a member has met the requirements of the extension risk coverage, e.g. a member reaches age 75 and 20 years participation in the plan, the welfare benefits trust 104 may elect to collect the proceeds of the extension risk coverage. In such an event, the extension risk carrier 112 purchases from the special purpose captive insurance company 108 the life insurance coverage, which consists of the life re-insurance coverage, or the coverage self-insured by the special purpose captive insurance company 108, and cash value attributable to such qualifying plan member, in exchange for the proceeds of the extension risk coverage attributable to such member. The special purpose captive insurance company 108 then pays the proceeds of the extension risk coverage attributable to such member to the welfare benefits trust 104, whereupon the procedure of paying back the lender and/or the bond holders 106 is analogous to that described above. The amount of the extension risk coverage is actuarially determined to provide the welfare benefits trust 104 with sufficient proceeds to retire the outstanding principal and accrued interest on the loans and/or the bonds and/or other debt instruments attributable to such qualifying member and to retain the present value of the cost of its future benefit obligations to such qualifying member. The extension risk carrier 112 retains the life re-insurance proceeds that are payable upon the death of the member.

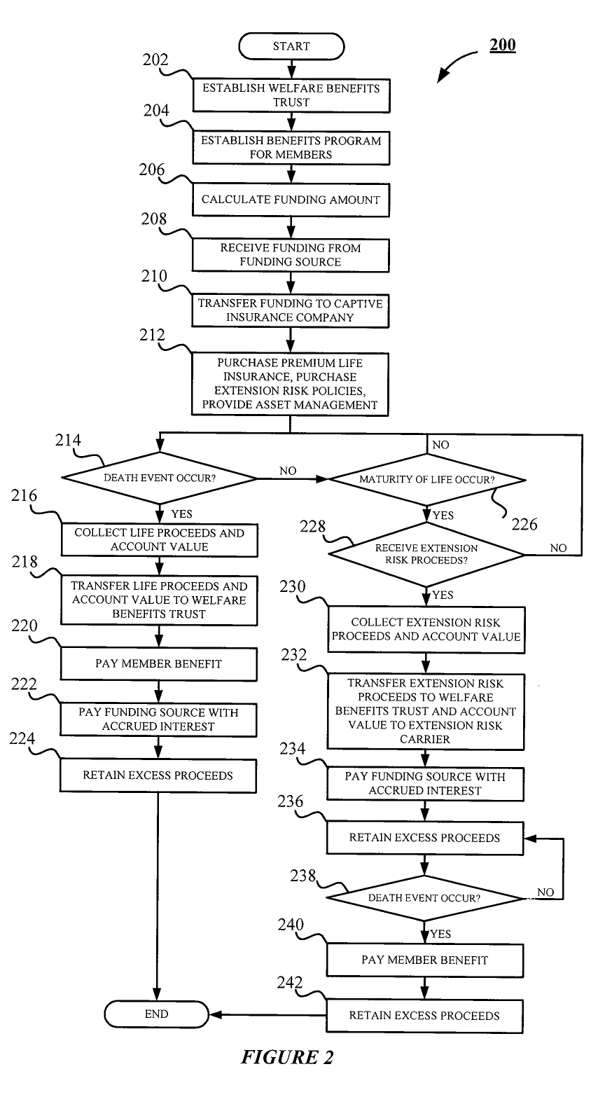

The foregoing system 100 illustrated in FIG. 1 will better be understood when viewed in conjunction with the methodologies set forth in FIG. 2. Turning now to FIG. 2, there is shown a flowchart 200 illustrating a method for a financed welfare benefits trust in accordance with one embodiment of the subject application. Beginning at step 202, the method commences by a respective legal entity 102 establishing a welfare benefits trust 104. As mentioned above, the legal entity 102 is capable of being a governmental entity, a private company, a publicly traded company, a corporation, an association, a union, including multiple entities or organizations, and the like. A benefits program is then established by the welfare benefits trust 104 at step 204 for the associated members. In accordance with example embodiment of the subject application, when a life insurance benefit is to be provided to members of the trust 104, the welfare benefits trust 104 then establishes a group life insurance plan with at least one additional life insurance carrier 116. At step 206, a funding amount is calculated to provide purchasing of life insurance for respective members of the welfare benefits plan and of extension risk coverage and to provide for establishing a policy cash value fund. The funding amount is calculated based on stochastic actuarial models and modern financial theory. As will be apparent to those skilled in the art, the members of the welfare benefits plan are capable of being employees, union members, and the like.

Flow then proceeds to step 208, at which step the funding amount is received from the funding source, e.g. the lender/holder 106, by the welfare benefits trust 104. Once the funding amount is received, the funding amount is then transferred, at step 210, to the special purpose captive insurance company 108, which issues a life insurance policy to the welfare benefits trust 104. As will be recognized by those skilled in the art, the special purpose captive insurance company 108 is capable of issuing a single policy or a series of policies to the welfare benefits trust 104. In accordance with one embodiment of the subject application, the determined funding amount is obtained via debt instrument issuance by the welfare trust 104, procurement of one or more loans from a suitable lender, or any suitable combination thereof. As will be recognized by those skilled in the art, the special purpose captive insurance company 108 is capable of being a cell of an existing captive insurance company, with the welfare benefits trust 104 being its sole client. As is known in the art, captive insurance companies are typically limited purpose insurance companies established with the specific objective of insuring against specifically-defined risks emanating from a designated legal entity or group of legal entities. Next, at step 212, the special purpose captive insurance company 108 purchases life insurance for respective plan members from an insurance company 110, which may also be the special purpose captive insurance company 108, and purchases extension risk coverage for each pool of lives from an extension risk carrier 112, which may also be the special purpose captive insurance company 108. At step 212, the captive insurance company 108 also provides for asset management by a respective asset management institution 114, such as world class fixed income managers. As will be recognized by those skilled in the art, the insurance company 110 is capable of including, when appropriate, multiple life insurance companies. The skilled artisan will further appreciate that the extension risk carrier 112 and the asset management institution 114 are also capable of including multiple respective companies.

Once life insurance for respective plan participants and extension risk coverage is purchased by the captive insurance company 108 and asset management is provided, flow proceeds to step 214. At step 214, a determination is made as to whether a death event has occurred with respect to at least one plan member. If the determination is positive, flow proceeds to step 216, at which step the captive insurance company 108 collects life insurance proceeds from the insurance company 110 and collects cash value fund value from the asset management company 114 with respect to the at least one deceased plan member. The extension risk coverage for the deceased plan member lapses at this point. At step 218 the captive insurance company 108 transfers collected amounts to the welfare benefits trust 104 as a death benefit under the provisions of the life insurance policy issued by the captive insurance company 108 to the welfare benefits trust 104 at the outset. Once the welfare benefits trust 104 has received the collected amounts, it pays, at step 220, the at least one additional life insurance company 116 to fund the group life insurance plan for the at least one deceased plan member. The at least one additional life insurance company 116 pays the at least one member benefit to the at least one deceased member's beneficiaries. At step 222, the welfare benefits trust 104 pays the balance of the funding amount (loan, bonds, etc.) attributable to deceased plan member together with accrued interest to the funding source, e.g. the lender/holder 106. At step 224, the welfare benefits trust 104 retains the excess proceeds to provide additional member benefits or to reduce further the amount of the outstanding loans or debt obligations if required by the lender/holder 106. In one embodiment, the welfare benefits trust 104 further invests the excess proceeds pursuant to the welfare benefits trust's 104 investment policy statement, the requirements of the lenders and/or the bonds issued by the welfare benefits trust, and applicable state and federal requirements.

Returning now to step 214, when no death event occurs, that is, when a negative determination is made, flow proceeds to step 226. At step 226, a determination is made as to whether a maturity of life event has occurred with respect to at least one plan member. As will be recognized by one skilled in the art, a maturity of life event is capable of including, for example and without limitation, a member's age reaching 75, his or her membership in the plan reaching 20 years, or the like. If the determination is positive, flow then proceeds to step 228, at which step the welfare benefits trust 104 determines whether it wishes to receive the extension risk proceeds from the captive insurance company 108 at that time. If the determination is positive, the welfare benefits trust 104 SO notifies the captive insurance company 108, and flow then proceeds to step 230, at which step the captive insurance company 108 collects the extension risk proceeds from the extension risk carrier 112, which it transfers to the welfare benefits trust 104. At step 230, the captive insurance company 108 also collects the proceeds from the cash value account from the asset management company 114 with respect to the at least one plan member for whom the maturity of life event has occurred. The captive insurance company 108 then transfers, at step 232, the life insurance coverage, consisting of the collected cash value account proceeds and the life insurance coverage for the at least one plan member, to the extension risk carrier 112. The flow then proceeds to steps 234 through 236, in the manner discussed above for steps 222 through 224.

Returning now to steps 226 and 228, when a negative determination is made, that is, when no maturity event occurs in step 226 or when the welfare benefits trust 104 determines at step 228 that it does not wish to receive at that time the extension risk proceeds, flow proceeds to steps 214 through 224 in the manner already discussed in detail above.

Returning now to step 236, once excess proceeds are retained after payment of the loan with accrued interest due to an occurred maturity of life event with respect to at least one plan member, flow then proceeds to step 238. At step 238, a determination is made as to whether a death event has occurred subsequent to the maturity of life event with respect to at least one plan member. If the determination is positive, flow proceeds to step 240, at which step the welfare benefits trust 104 pays the at least one additional life insurance company 116 to fund the group life insurance plan for the at least one deceased plan member. The at least one additional life insurance company 116 pays out the member benefit to the member's beneficiary from the retained assets. At step 242, the welfare benefits trust 108 retains the excess proceeds in the manner discussed above with respect to step 224. Returning now to step 238, when the determination is negative, that is, no death event occurs subsequent to the maturity of life event with respect to at least one plan member, flow proceeds to steps 236 through 242 in the manner already discussed in detail above.

As will be appreciated by those skilled in the art, described above is a life insurance strategy that provides life insurance for members with no cost to members, and, in accordance with the subject strategy, recovers funding costs, such as loan plus interest, and provides excess death benefit and cash values to finance additional benefits to current and/or future members—actuarial and investment gains build in the legal entity's trust and under its management and control. The strategy is based on life insurance purchased recognizing large groups (plan members), on certainty of capital events over time, and on extension risk coverage (benefit certainty during life time). The strategy takes advantage of insurance structures and actuarial science and of the low cost of capital today, huge amounts of capital available seeking consistent returns with low volatility and long-term view. In accordance with the strategy, the loan has recourse only to trust assets, including insurance coverage and rights and assets under management, trust gains, and to other assets held by or for the benefit of the special purpose captive insurance company. Those skilled in the art will further appreciate that the extension risk coverage is effective with large groups such as, for example, 15,000 members, and is not intended to be purchased for a single life. In accordance with the insurance strategy described above, mortality and investment experience results in significant benefits to the participants in the welfare benefit trust and provides for cost recovery of all costs to the funder/lender. Actuarial gains and investment gains could develop trust surplus, which can be used under the rules and regulations of the welfare benefits trust for other benefits and/or for providing similar benefits to additional members of the group.

It will become apparent to those skilled in the art that the system and method for financed welfare benefits trust described herein are suitably adapted to be implemented by employing, for example and without limitation, multiple workstations in data communication with a computer network via corresponding communications links. Each of the multiple workstations is representative of any personal computing or user device known in the art including, for example and without limitation, a laptop computer, a personal computer, a personal data assistant, a web-enabled cellular telephone, a smart phone, a proprietary network device, or other web-enabled electronic device. The multiple communications links are capable of being implemented as any suitable channel of data communications known in the art including but not limited to wireless communications, for example and without limitation, BLUETOOTH, WIMAX, 802.11a, 802.11b, 802.11g, 802.11(x), a proprietary communications network, infrared, optical, the public switched telephone network, or any suitable wireless data transmission system or wired communications known in the art. Preferably, the multiple workstations are suitably adapted to generate, transmit, and receive electronic documents, document processing instructions, user interface modifications, upgrades, updates, personalization data, or the like via the computer network.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the subject application.

What is claimed is:

1. A method for financing benefits, comprising the steps of:
establishing a welfare benefits trust having a plurality of associated members;
establishing a benefits program associated with the welfare benefits trust for the plurality of associated members;
determining an amount of funding corresponding to the established welfare benefits trust in accordance with at least one of the group consisting of a stochastic actuary model and a modern financial theory;
receiving determined funding from at least one funding source;
transferring received funding to at least one special purpose captive insurance company; and
procuring, by the at least one special purpose captive insurance company, at least one of the group consisting of life insurance, extension risk coverage, and asset management.

2. The method of claim 1, further comprising the steps of:
determining an interest payment due the at least one funding source; and
paying the determined interest payment due the at least one funding source in accordance with a predetermined interval.

3. The method of claim 2, further comprising the step of borrowing against a cash value associated with the procured life insurance so as to pay the determined interest at the predetermined interval.

4. The method of claim 1, further comprising the step of purchasing at least one re-insurance policy from at least one re-insurance company.

5. The method of claim 1, further comprising the steps of:
receiving, upon a death occurrence of at least one associated member, proceeds associated with a life insurance policy corresponding to the deceased member by the at least one special purpose captive insurance company;
receiving, upon the death occurrence of the at least one associated member, member attributable proceeds of a policy cash value fund associated with the asset management corresponding to the deceased member by the at least one special purpose captive insurance company;
paying the received proceeds to the established welfare benefits trust by the at least one special purpose captive insurance company; and
arranging payment of a member benefit corresponding to an attributable portion of the proceeds.

6. The method of claim 5, further comprising the step of retaining excess proceeds after payment of the member benefit.

7. The method of claim 5, further comprising the step of reducing an amount of outstanding funding due the at least one funding source in accordance with excess proceeds received from the special purpose captive insurance company.

8. The method of claim 1, wherein the step of determining an amount of funding is based upon at least one of the group consisting of a life insurance cost, an extension risk cost, a policy cash value fund, and a cost associated with at least one special purpose captive insurance company.

9. The method of claim 1, wherein the at least one funding source comprises at least one of the group consisting of a lender, a debt instrument issuance, a self-funding source, and a sponsor associated with the welfare benefits trust.

10. A system for financing benefits, comprising:
means for establishing a welfare benefits trust having a plurality of associated members;
means for establishing a benefits program associated with the welfare benefits trust for the plurality of associated members;
means for determining an amount of funding corresponding to the established welfare benefits trust in accordance with at least one of the group consisting of a stochastic actuary model and a modern financial theory;
means for receiving determined funding from at least one funding source;
transfer means for transferring received funding to at least one special purpose captive insurance company; and
means for procuring, by the at least one special purpose captive insurance company, at least one of the group consisting of life insurance, extension risk coverage, and asset management.

11. The system of claim 10, further comprising:
means for determining an interest payment due the at least one funding source; and
means for paying the determined interest payment due the at least one funding source in accordance with a predetermined interval.

12. The system of claim 11, further comprising borrowing means for borrowing against a cash value associated with the procured life insurance so as to pay the determined interest at the predetermined interval.

13. The system of claim 10, further comprising means adapted for purchasing at least one re-insurance policy from at least one re-insurance company.

14. The system of claim 10, further comprising:
means for receiving, upon a death occurrence of at least one associated member, proceeds associated with a life insurance policy corresponding to the deceased member by the at least one special purpose captive insurance company;
means for receiving, upon the death occurrence of the at least one associated member, member attributable proceeds of a policy cash value fund associated with the asset management corresponding to the deceased member by the at least one special purpose captive insurance company;
means for paying the received proceeds to the established welfare benefits trust by the at least one special purpose captive insurance company; and
means for paying a member benefit corresponding to an attributable portion of the proceeds.

15. The system of claim 14, further comprising retaining means for retaining excess proceeds after payment of the member benefit.

16. The system of claim 14, further comprising reduction means for reducing an amount of outstanding funding due the at least one funding source in accordance with excess proceeds received from the special purpose captive insurance company.

17. The system of claim 10, wherein the determining means determines an amount of funding is based upon at least one of the group consisting of a life insurance cost, an extension risk cost, a policy cash value fund, and a cost associated with at least one special purpose captive insurance company.

18. The system of claim 10, wherein the at least one funding source comprises at least one of the group consisting of a lender, a debt instrument issuance, a self-funding source, and a sponsor associated with the welfare benefits trust.
